(19) United States
(12) Patent Application Publication
(10) Pub. No.: US 2020/0247206 A1
(43) Pub. Date: Aug. 6, 2020

(54) SEALING APPARATUS FOR AN AIR SUSPENSION DEVICE, AIR SUSPENSION DEVICE, AND METHOD FOR SEALING A PRIMARY VOLUME IN AN AIR SUSPENSION DEVICE

(71) Applicant: SAF-HOLLAND GmbH, Bessenbach (DE)

(72) Inventor: Bernd Brunsch, Dreieich (DE)

(21) Appl. No.: 16/641,936

(22) PCT Filed: Aug. 22, 2018
(86) PCT No.: PCT/EP2018/072637

§ 371 Date: Feb. 25, 2020

(30) Foreign Application Priority Data
Aug. 29, 2017 (DE) 10 2017 119 736.2

(51) Int. Cl. B60G 11/30; B60G 11/27; F16F 9/36; F16F 9/05; F16F 9/04; B60G 15/12

(52) U.S. Cl. CPC B60G 11/30; F16F 2224/02; F16F 9/369; F16F 9/057; F16F 9/049; F16F 9/05; F16F 9/0481; B60G 15/12; B60G 2206/73; B60G 2206/71; F16F 2230/30; B60G 2202/154; B60G 2202/152; B60G 2206/42; B60G 2800/162; F16F 2224/025; B60G 11/27

(57) ABSTRACT

A sealing apparatus for an air spring device for sealing a primary volume of the air spring device in particular a working volume of the air spring device, with respect to a secondary volume, including a main body, and a sealing element configured on the circumference of the main body, the sealing element configured such that, in a state in which it is mounted in the air spring device, the sealing element is transferred from a sealed position, in which the sealing element seals the primary volume with respect to the secondary volume, into a released position, in which air passes the sealing element, when a pressure difference between the primary volume and the secondary volume, which pressure difference is set with respect to the secondary volume as a negative pressure in the primary volume, exceeds a threshold value.

### BACKGROUND OF THE INVENTION

The present invention relates to a sealing apparatus for an air spring device, to an air spring device, and to a method for sealing a primary volume in an air spring device by way of a sealing apparatus.

Air spring devices are typically used for cushioning a vehicle axle or for changing a ride height position of a vehicle. Customary constituent parts of the air spring device are a piston element and an air bellows element, it being possible for the air bellows element and the piston element to be moved relative to one another. Here, the air bellows element rolls on an outer face of the piston element in the case of a compression and rebound. To this end, the air bellows element is preferably manufactured from an elastic material, by way of which a folding movement can be brought about during the rolling. In addition, a damping action is brought about by virtue of the fact that a fluid, in particular air, flows to and from via a constricted cross section between the surroundings and a working space which is provided by way of the air bellows element and the piston element. The vibrations which are introduced are damped on account of the constricted cross section and the associated friction. Air spring devices of this type are typically arranged on commercial vehicles, such as on a semi-trailer or a semi-trailer tractor. When the semi-trailer is then lifted, the air spring device is stretched, with the result that there is a negative pressure in the volume which is enclosed by the air bellows element as a consequence of the associated increase in the working volume, which in turn leads to it being possible for the elastic air bellows element to be deformed or collapsing toward the inside, that is to say in the direction of the working volume. In the case of the subsequent setting down of the semi-trailer, the air bellows element can be pinched and can even be damaged as a consequence. In order to avoid a phenomenon of this type, the prior art is aware of multiple-piece plunger piston elements and/or head plates or, in addition, suction valves (for example, in the head plate). Said solutions cannot be used universally, however. For example, the possibility of the use of the split plunger piston element is canceled if the plunger piston element itself is under pressure. In addition, there is not the required installation space in many applications.

It is therefore an object of the present invention to provide an air spring device, by way of which the probability of damage of the air bellows element can be reduced in a way which is as simple as possible, inexpensive and universally applicable.

### SUMMARY OF THE INVENTION

According to the invention, a sealing apparatus for an air spring device is provided for sealing a primary volume of the air spring device, in particular a working volume of the air spring device, with respect to a secondary volume, comprising a main body and a sealing element which is configured on the circumference of the main body, the sealing element being configured in such a way that, in a state in which it is mounted in the air spring device, the sealing element is transferred from a sealed position, in which the sealing element seals the primary volume with respect to the secondary volume, into a released position, in which air passes the sealing element, when a pressure difference between the primary volume and the secondary volume, which pressure difference is set with respect to the secondary volume as a negative pressure in the primary volume, exceeds a threshold value. As a result, it can be ensured by means of the sealing apparatus in a simple way that a pressure equalization can take place as soon as a positive pressure is produced in the primary volume, which positive pressure might lead to damage of the air spring device, in particular to damage of the air bellows element. With respect to the configuration according to the claim of the sealing element, its geometric shape and/or material composition are/is adapted here. In particular, the geometric shape and/or the material composition can be adjusted in such a way that the threshold value for the pressure difference is fixed by way of the selection of said geometric shape and/or material composition. As a result, it is advantageously possible that an air equalization does not take place immediately when a negative pressure is configured in the primary volume, but rather only when a critical pressure difference is set, for example a pressure difference which is to be expected for the collapsing of the air bellows element. It is preferably provided that the sealing element is bent or deformed for the transfer into the released state, in particular as a consequence of the pressure difference between the primary volume and the secondary volume. For example, the working volume between the air bellows element and the piston element forms the primary volume, whereas the secondary volume can be an additional volume in an additional container or a surrounding area of the air spring device. Furthermore, the circumference is to be understood to mean the outermost contour in a plane which runs perpendicularly with respect to the axial direction in the mounted state of the sealing apparatus; the piston element and the air bellows element can be displaced with respect to one another along the axial direction and/or are moved along the axial direction in the case of compression and rebound. Furthermore, the axial direction runs substantially perpendicularly with respect to the upper side of a link or a link-side interface, to which the air spring device is attached. It is particularly preferably provided that the sealing apparatus is provided for an air spring device of a commercial vehicle, for example a semi-trailer. For example, the sealing element is adapted to the negative pressure which results in the case of the air spring device being pulled apart in the axial direction when the semi-trailer is lifted, in order to attach it to a semi-trailer tractor.

The sealing apparatus is advantageously configured in one piece. In other words, this can mean that the main body and the sealing element are configured in one piece with one another. Said single-piece configuration results in a particularly tight and mechanically durable sealing apparatus.

The sealing element and/or the main body expediently consist/consists at least partially, preferably completely, of a rubber and/or plastic. A sealing apparatus with a particularly satisfactory seal can be achieved as a result. In order to obtain a mechanically durable main body, it can be preferred if said main body has a metallic supporting body.

It is preferably provided that the sealing element is configured as a sealing lip, in particular as a flexible sealing lip. It is conceivable here that the sealing lip tapers in a radial direction which runs perpendicularly with respect to the axial direction with regard to its thickness. Furthermore, it is conceivable that the sealing element, in particular the sealing lip, is manufactured from a different material than the main body. For example, the sealing lip is already bent or has a bent contour course in the non-mounted state. As a result, a contact area which is configured in the sealed position can advantageously be increased. The sealing apparatus preferably comprises a reinforcing element, such as a wire or a wire mesh. The configurations which are described here serve, in particular, for making it possible for the sealing element to be transferred into the released state in the case of the threshold value being reached.

Furthermore, it is preferably provided that the main body is configured as a ring or as a cylinder. The basic shape of a ring or cylinder is particularly suitable for circumferential sealing in the air spring device, since its components, for example the piston element or the connecting duct, have a substantially completely rotationally symmetrical course with respect to the axial direction. If the sealing apparatus is configured as a ring, the sealing apparatus can additionally be pulled onto or arranged on components which are already provided in the air spring device.

It is expediently provided that it is possible for the sealing apparatus to be integrated into a stop element, or the main body forms at least one part of the stop element. A stop element is preferably to be understood to mean a component of the air spring device, which component is intended to prevent or damp contact of the piston element with a head plate of the air spring device. To this end, the stop element is preferably manufactured from an elastic material, in particular a rubber material. As a result of the integral configuration of the stop element and the sealing apparatus, the number of components which are to be assembled during mounting is advantageously reduced. As an alternative, it is conceivable that the stop element has a circumferential cutout or a circumferential recess, into which the sealing apparatus can be inserted. In this case, the sealing apparatus can be inserted simply in a manner which saves installation space and, in particular, can be replaced simply if required, without it being necessary for the entire stop element to be exchanged.

It is preferably provided that an angle which is measured in the non-mounted state between the circumferential face or that face of the main body, on which the sealing lip is arranged, and the sealing lip assumes a value of between 30° and 80°, preferably of between 35° and 55°, and particularly preferably of between 42° and 48°. As a result of the angled configuration of the sealing lip, a direction can advantageously be defined, in which direction the sealing lip bends when it is transferred into the released position. The sealing lip preferably bends in the direction of an air flow which passes the sealing apparatus. It has been proved, in particular, for an angular range of between 42° and 48° that a comparatively short and thin sealing element can be realized which, in addition, fulfills the requirement of sufficient sealing in the sealed position and can be bent over simply for the transfer into the released state.

It is expediently provided that a ratio between an outermost diameter of the main body to an outermost diameter of the sealing element assumes a value of between 0.78 and 0.98, preferably of between 0.91 and 0.97, and particularly preferably of between 0.87 and 0.96. A comparatively long sealing element can be bent without a great effort and/or can already be bent in the case of a small pressure difference. It has been proven for the value range of between 0.87 and 0.96 that the sealing elements are particularly dimensionally stable and can thus ensure a firm seat of the sealing apparatus by way of the corresponding press fit in the sealed position.

It is preferably provided that the sealing element projects with respect to the main body as viewed in the axial direction. This can bring about a situation, for example, where a contact point, against which the sealing element bears sealingly in the sealed position, is set in the axial direction with respect to the main body. In other words, the contact point in the air spring device can be fixed by way of the dimensioning of the sealing element, as a result of which the sealing apparatus can advantageously be adapted to the installation space precondition of the respective air spring device.

Furthermore, according to the invention, an air spring device, in particular for commercial vehicles, is provided, comprising an air bellows element, a piston element, a primary volume which is configured between the air bellows element and the piston element, and a sealing apparatus for sealing the primary volume of the air spring device, in particular a working volume of the air spring device, with respect to a secondary volume, with a main body and a movable or flexible sealing element which is configured or arranged on the circumference of the main body, the sealing element being configured in such a way and, in the mounted state, being arranged in such a way that the sealing element is moved from a sealed position, in which the sealing element seals the primary volume with respect to the secondary volume, into a released position, in which air passes the sealing element, when a pressure difference between the primary volume and the secondary volume, which pressure difference is set with respect to the secondary volume as a negative pressure in the primary volume, exceeds a threshold value. All of the features which are described for the sealing apparatus according to the invention and their advantages can likewise be transferred analogously to the air spring device according to the invention and vice versa.

It is provided, in particular, that the air bellows element and the piston element are configured in such a way that they can be moved with respect to one another as viewed in the axial direction. An expedient arrangement of the sealing apparatus in the air spring apparatus is preferably to be understood to mean an arrangement of the kind, in which that end of the sealing element which faces away from the main body in the radial direction is directed onto the primary volume. Furthermore, it is provided that the sealing apparatus is configured in such a way that it can be inserted into the air spring device with a press fit. As a result, a secure seat of the sealing apparatus in the air spring device and sufficient sealing in the sealed position can be ensured.

A connecting duct for the exchange of air between the primary volume and the secondary volume, in particular an additional volume, is expediently provided, the sealing apparatus being arranged in the connecting duct. As a result, the additional volume of an additional container which is arranged, for example, on that side of the link which lies opposite the piston element, that is to say below the link, can advantageously be used for the pressure equalization. In this case, a seal is provided in any case in the connecting duct, with the result that merely the seals which are provided here from the prior art have to be replaced by the sealing apparatus according to the invention, that is to say additional complexity and additional costs are kept as low as possible and no additional installation space is taken up.

It is provided, in particular, that the sealing apparatus is arranged above the piston element as viewed in the axial direction, in particular on or above an upper side of the piston element, which upper side faces the primary volume and preferably adjoins the connecting duct. As a result, the sealing apparatus can be arranged comparatively simply at its intended location and/or can be removed again for replacement, since access is more accessible in comparison with the arrangement within the connecting duct, in particular as soon as the air bellows element has been removed. Furthermore, it is preferably provided that the upper side runs obliquely and advantageously serves as a guide in the case of the attaching or applying of the sealing apparatus. The oblique course of the upper side is additionally advantageous for sealing in the sealed position, since as great a contact area as possible can be realized between the obliquely running upper side and the sealing element. The angle between the main body and the sealing element is preferably adapted to the inclination of the upper side.

It is expediently provided that, in the mounted state, the air bellows element is fixed on the upper side of the piston element, preferably via a bead which, in the mounted state, is clamped between a side wall of the upper side and a further wall of the upper side. It is also conceivable that the sealing apparatus is configured as a projection of the air bellows element, in particular as a projection of the bead. In other words, the sealing apparatus can be an integral constituent part of the air bellows element. Here, in the sealed position, the sealing element can make contact, for example, with the upper side of the piston element or the circumference of the stop element, in particular can make contact in a sealing manner.

In particular, cutouts for the exchange of air with the surroundings are provided in the piston element, the cutouts adjoining the sealing apparatus, in particular. As a result, the air which surrounds the air device can advantageously be drawn on in respect of the pressure equalization. The cutout is preferably made below the sealing apparatus as viewed in the axial direction. Furthermore, it is provided that the sealing apparatus is configured in such a way that a clearance is formed between the cutout and the sealing element. As a result, air can be introduced into said clearance or cavity for bending the sealing element, with the result that the secondary volume is arranged in the immediate vicinity of the sealing element. That is to say, the secondary volume lies at least partially between the piston element, in particular the upper side of the piston element, and the sealing apparatus or the sealing element.

Furthermore, it is preferably provided that a further cutout is provided in an outer wall of the piston element, a ratio between a spacing (measured in the axial direction) of the further cutout from a link to the overall extent of the piston element in the axial direction assuming a value of between 0.05 and 0.45, preferably of between 0.28 and 0.38 and particularly preferably of between 0.32 and 0.35 in the mounted state. This can advantageously ensure that the further cutout is not covered by the air bellows element during operation.

In addition or as an alternative, it is provided that, in the mounted state, a ratio between a spacing (measured in the axial direction) of the further cutout from a link to the overall extent of the piston element in the axial direction assumes a value of between 0.95 and 0.65, preferably of between 0.85 and 0.65, and particularly preferably of between 0.72 and 0.78. As a result, the further cutout is arranged so close to the upper side of the piston element that the air bellows element releases the further cutout and permits the pressure equalization by way of an exchange of air with the primary volume only in the case of said air bellows element being stretched, for example in the case of lifting of the semi-trailer. As a result, an additional (securing) mechanism is provided which restricts a transfer into the release state to those situations, in which the air spring device or the air spring bellows element is actually overstretched or is stretched excessively far.

It is expediently provided that the cutout and/or the further cutout comprise/comprises a grill for avoiding the penetration of foreign bodies. This can advantageously prevent foreign bodies from collecting unintentionally in the air spring device, which foreign bodies subsequently impede or restrict the operation of said air spring device. Furthermore, the piston element can be reinforced further by way of the grill.

It is preferably provided that the sealing element bears against an inner side of the connecting duct or a side wall on the upper side of the piston element in the sealed position.

It is expediently provided that, in order to avoid a maximum stretch of the air bellows element, the air spring device, in particular the piston element and/or the head plate, is configured in two pieces on the link side and/or on the vehicle body side. In particular, the maximum stretch of the air bellows element can be avoided by, in the case of a pulling-apart force which acts on the air spring device, a first part following the pulling-apart force, whereas the second part serves as a return or guide of the first part in the case of the return into the starting position. It is a consequence of the joint movement of the first part that the air bellows element is not overstretched and a negative pressure which would otherwise be produced can thus already be counteracted. In this case, the sealing apparatus serves additionally as a securing means if the functionality of the link-side and/or vehicle body-side two-piece configuration is restricted or prevented.

Furthermore, a method is in accordance with the invention for sealing a primary volume in an air spring device by way of a sealing apparatus which has a main body and a movable sealing element which is configured on the circumference of the main body, the sealing element being transferred, in a state in which it is mounted in the air spring device, from a sealed position, in which the sealing element seals the primary volume with respect to a secondary volume, into a released position, in which air passes the sealing element, when a pressure difference between the primary volume and the secondary volume, which pressure difference is set with respect to the secondary volume as a negative pressure in the primary volume, exceeds a threshold value.

All of the features which are described for the sealing apparatus according to the invention and the air spring device according to the invention and their advantages can likewise be transferred analogously to the method according to the invention and vice versa.

### BRIEF DESCRIPTION OF THE DRAWINGS

Further advantages and features result from the following description of preferred embodiments of the subject matter according to the invention with reference to the appended figures. Individual features of the individual embodiments can be combined with one another here within the scope of the invention.

In the figures:

FIGS. 1a and 1b show an air spring system in accordance with one preferred embodiment of the present invention;

FIGS. 2a and 2b show an air spring device and a link of the air spring system from FIG. 1a in plan views; and

FIGS. 3a and 3b show a detailed view of the air spring device from FIG. 2a.

### DETAILED DESCRIPTION OF THE PREFERRED EMBODIMENTS

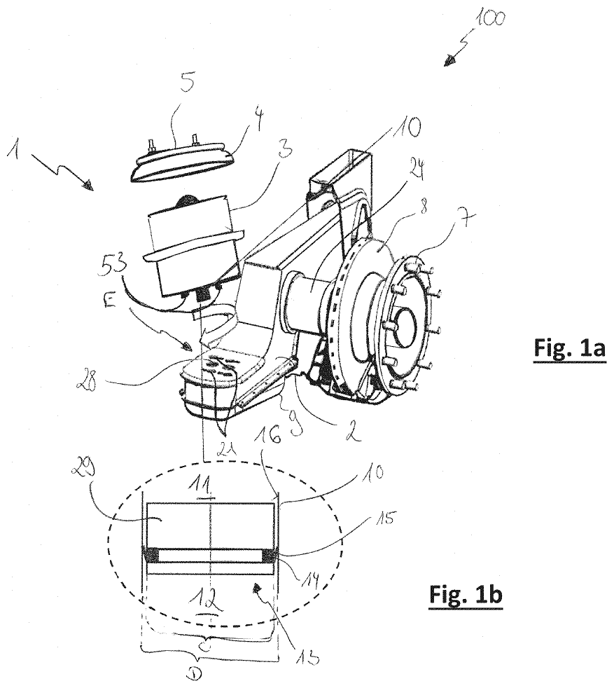

FIGS. 1a and 1b show an air spring system 100 in accordance with a first preferred embodiment of the present invention. In particular, this is an air spring system 100 which is provided for cushioning a wheel axle 24 on a commercial vehicle, for example a semi-trailer. A wheel hub 7 and a brake disk 8 are attached, for example, on the wheel axle 24. Essential constituent parts of an air spring system 100 of this type are a link 2 and an air spring device 1. The link 2 is preferably attached, for example at its one end, to a vehicle body such that it can be pivoted about a pivot axis, and supports the wheel axle 24. In order to damp a translational movement, for example an up and down movement, of the wheel axle 24 during operation, the link 2 is attached via the air spring device 1 to a further region of the vehicle body, which further region is spaced apart from the pivot axis. In addition to the cushioning of the wheel axle 24, the air spring system 100 is also used to change a ride height position of a vehicle. Here, essential constituent parts of the air spring device 1 are preferably a piston element 3 and an air bellows element 4, it being possible for the air bellows element 4 and the piston element 3 to be displaced relative to one another. Here, in the case of a compression and rebound, the air bellows element 4 rolls on an outer face of the piston element 3. To this end, the air bellows element 4 is preferably manufactured from an elastic material, by way of which a folding movement can be brought about during the rolling. In addition, a damping action is brought about by virtue of the fact that a fluid, in particular air, flows to and from via a constricted cross section between a working volume or primary volume 11 which is provided by way of the air bellows element 4 and the piston element 3 and a secondary volume 12 or chamber which is configured in the piston. The vibrations which are introduced are damped on account of the constricted cross section and the associated friction.

The damping behavior of an air spring device 1 of this type is dependent on the available air volume. In order to increase the volume, it is therefore known to connect the working space to an additional container 9 which provides an additional volume. In particular, the additional container 9 and the air spring device 2 are connected fluidically via a connecting duct 10 in the mounted state. It is provided, in particular, that the air spring device 1 is attached on an upper side of the link 2, which upper side faces the chassis, whereas the additional container 9 is attached on a lower side of the link 2, which lower side faces away from the chassis. In order to avoid locking elements which fill the installation space, it is provided, in particular, that the link 2 has one or more engagement regions 21 in an interface region E, in which the air spring device 1 is attached to the link 2, which engagement region/regions interacts/interact in a positively locking manner with a positively locking element 53 of the air spring device 1, in particular of the piston element 3. In the exemplary embodiment which is shown, the positively locking elements 53 are a hook element which is arranged on an end side of the air spring device 2, in particular of the piston element 3, which end side faces the link 2 in the mounted state. It is provided, in particular, that the link-side engagement region 21 and the air spring device-side positively locking element configure a bayonet closure. Here, the connecting duct 10 is plugged through a corresponding opening 28 in the link 2, in order to achieve the connection to the additional container 9.

In order to avoid the air bellows element 4 deforming in the direction of the primary volume 11 in the case of a negative pressure which is configured in the primary volume 11, a sealing apparatus 13 is provided in the connecting duct 10 in the embodiment from FIG. 1. A negative pressure of this type can be produced, for example, when the vehicle body of a semi-trailer is lifted in the case of the attachment of the semi-trailer to a semi-trailer tractor, and the air spring device 1 and therefore the primary volume 11 are stretched. The negative pressure which is configured with respect to the surroundings necessitates a deformation of the air bellows element in the direction of the primary volume 11 or working volume, that is to say the air bellows element 4 collapses. In the case of subsequent lowering of the vehicle body of the semi-trailer, damage to the air spring device 1, in particular to the air bellows element 4, can occur as a consequence of the compression of the air spring device 1. In order to avoid this, the sealing apparatus 13 is provided in the connecting duct 10 in the embodiment which is shown in FIG. 1. Here, the sealing apparatus 13 is shown in a detailed view and, in addition to a main body 14, comprises a sealing element 15 which is formed on the circumference of the main body 14. The sealing element 14 is, in particular, a sealing lip which is directed with its outermost circumference as viewed in the radial direction or with its end 20 which faces away from the main body 14 toward the primary volume 11. As a result of said geometry of the sealing apparatus 13, it is possible in an advantageous way that the sealing element 13 is transferred, in a state in which it is mounted in the air spring device 1, from a sealed position, in which the sealing element 15 seals the primary volume 11 with respect to a secondary volume 12, into a released position, in which air passes the sealing element 15 when a pressure difference between the primary volume and the secondary volume, which pressure difference is set as a negative pressure in the primary volume 11 with respect to the secondary volume 12, exceeds a threshold value.

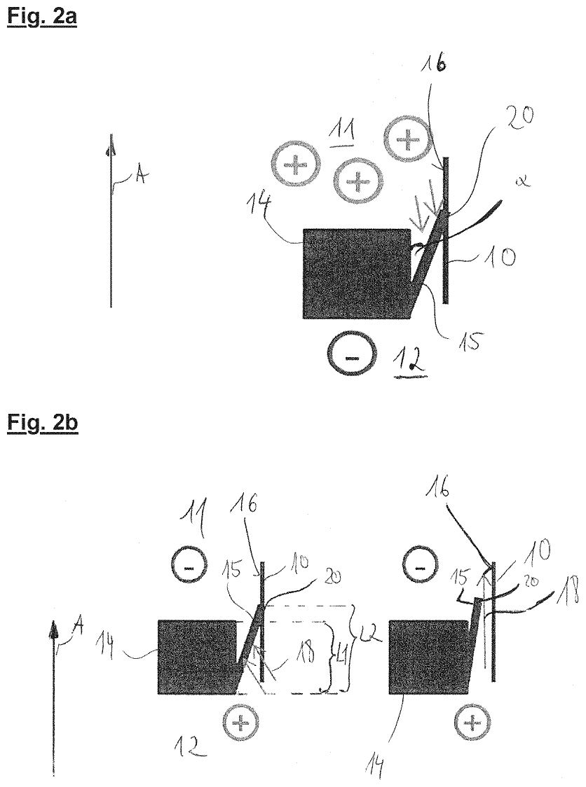

Here, FIG. 2a shows the sealing apparatus once again in the sealed position, whereas FIG. 2b illustrates the transition from the sealed position into the released position. Here, the + symbols which are provided with a circle symbolize a positive pressure, whereas the − symbols which are provided with a circle are intended to symbolize a negative pressure. It is apparent from FIG. 2b, furthermore, that the sealing element 15 is bent in the released position in such a way that an air flow 18 can pass the sealing apparatus 13, in order thus to ensure a pressure equalization between the primary volume 11 and the secondary volume 12. In order to bring it about that the sealing element 15 is bent in the case of a defined threshold value for the negative pressure being exceeded, the length, the thickness and/or the material of the sealing element 15 are preferably adapted accordingly. In the embodiment which is shown, it is provided, in particular, that the length L2 (measured in the axial direction) of the sealing element 15 is greater than a thickness L1 (measured in the same direction) of the main body. Furthermore, it is conceivable that the main body 14 is of cylindrical configuration, or that the sealing apparatus 13 comprises an annular main body 14 which can be inserted into a circumferential cutout of a closure element 29. As a result, existing air spring devices 1 can be retrofitted with the above-described sealing apparatus 13 if they comprise a closure element 29 of this type with a receptacle for a seal.

Furthermore, it is provided that a ratio between an outermost diameter C of the main body 14 to an outermost diameter B of the sealing element 15 assumes a value of between 0.78 and 0.98, preferably of between 0.91 and 0.97, and particularly preferably of between 0.87 and 0.96.

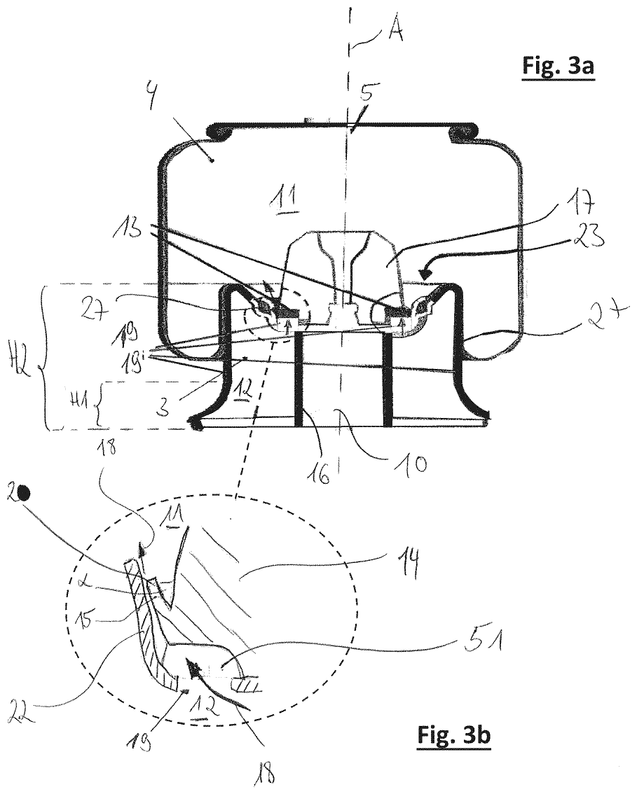

FIGS. 3a and 3b show an air spring device 1 in accordance with a second preferred embodiment of the present invention. Here, the embodiment of FIG. 3 differs from that from FIGS. 1 and 2 substantially only with regard to the arrangement of the seal device 13. It is provided, in particular, that the sealing device 13 lies on the piston element 3, in particular on an upper side 23 of the piston element 3. The upper side 23 of the piston element 3 is preferably to be understood to mean that side of the piston element which faces away from the link 2 and faces the primary volume 11, in particular that side which lies opposite a head plate 5 of the air spring device. The upper side 23 is preferably of curved or funnel-shaped configuration; in particular, the upper side 23 is of curved or funnel-shaped configuration in the direction of the link 2 in the mounted state. That is to say, the upper side 23 runs, coming from the outermost circumference of the piston element 3, in the direction of the center obliquely in the direction of the link 2. Here, the connecting duct 10 is arranged concentrically in the piston element 3, the connecting duct 10 projecting from the link 10 to a less pronounced extent than the piston element 3 in a direction which runs parallel to the axial direction A. It is also conceivable that the upper side 23 of the piston element 3 runs obliquely substantially by 45° with respect to the link 2 or with respect to the axial direction A. The air bellows element 4 is preferably attached via a bead 27 to the upper side 23 of the piston element 3. It is provided, in particular, that the sealing element 15 is configured in such a way that, in the mounted state, the sealing element 15 runs at least partially parallel to the upper side 23. As a result, flat contact of the sealing element 15 on the upper side 23, in particular on a side wall 22 of the upper side 23, can be realized in an advantageous way, which flat contact has an advantageous effect on the sealing action. In addition, the insertion of the sealing apparatus is simplified, since the oblique course of the side wall 22 can serve as a guide. In order that an exchange of air with the secondary volume 12 (here, the volume between the piston element 3 and the connecting duct 10 or the outer surroundings of the piston element 3) can be realized, cutouts 19 and/or further cutouts are provided. Cutouts 19 are preferably provided in the upper side 23 of the piston element 3, in particular below the sealing apparatus 13, especially below the main body 14, as viewed in a direction which runs parallel to the axial direction A. Here, the term “below” is preferably to be understood such that the cutout 19 is arranged between the sealing apparatus 13 and the link 2. Furthermore, a cavity 51 or clearance is provided which is configured above the piston element 3 or between the piston element and the sealing apparatus. Moreover, further cutouts 19′ are made in an outer wall 27 of the piston element 3, with the result that an exchange of air with the surroundings of the air spring device 1 can take place via the cutout 19 and the further cutout 19′. A ratio between a spacing H1 (measured in the axial direction) of the further cutout 19′ from the link 2 to the overall extent H2 of the piston element 3 preferably assumes a value of between 0.05 and 0.45, preferably of between 0.28 and 0.38, and particularly preferably of between 0.32 and 0.35. This advantageously ensures that the air bellows element does not accidentally cover the further cutout 19. Furthermore, it is conceivable that grills are integrated into the cutouts 19 or the further cutout 19′. It can advantageously be avoided by means of the grills that foreign bodies can pass into the air spring device 1.

Furthermore, a stop element 17, preferably a bump rubber, is provided which lies on the connecting duct 10 and the upper side 23 of the piston element 3. In the case of moving together or compression, said stop element 17 bears against a head plate 5 of the air spring device 1. In the embodiment which is shown by way of example in FIG. 3, the seal apparatus 13 is integrated here into the stop element 17, in particular on that side which faces the link 2 in the mounted state. The number of components can advantageously be limited by way of the integration into the stop element 17.

### LIST OF DESIGNATIONS

1 Air spring device
2 Link
3 Piston element
4 Air bellows element
5 Head plate
7 Wheel hub
8 Brake disk
9 Additional container
10 Connecting duct
11 Primary volume
12 Secondary volume
13 Sealing apparatus
14 Main body
15 Sealing element
16 Inner side
17 Stop element
18 Air flow
19 Cutout
19′ Further cutout
20 End
21 Engagement region
22 Side wall
23 Upper side
24 Axis
27 Outer wall
28 Opening
29 Closure element
51 Cavity
53 Positively locking element
H1 Spacing
H2 Overall extent
A Axial direction
C Diameter of the main body
D Diameter of the sealing element
E Interface region
L1 Length of the sealing element
L2 Thickness of the main body

1.-15. (canceled)

16. An air spring device for commercial vehicles, comprising:
an air bellows element;
a piston element;
a primary volume positioned between the air bellows element and the piston element; and
a sealing apparatus configured to seal the primary volume of the air spring device with respect to a secondary volume, the sealing apparatus including a main body and a movable sealing element positioned on the circumference of the main body;
wherein the sealing element is configured such that, in the mounted state the sealing element is movable from a sealed position where the sealing element seals the primary volume with respect to the secondary volume, to a released position where air passes the sealing element, when a pressure difference between the primary volume and the secondary volume exceeds a threshold value, wherein the pressure difference is set with respect to the secondary volume as a negative pressure in the primary volume, the air spring device having a connecting duct or the exchange of air between the primary volume and the secondary volume, the sealing apparatus being arranged in the connecting duct; and
wherein a ratio between an outermost diameter of the main body to an outermost diameter of the sealing element is between 0.78 and 0.98.

17. The air spring device as claimed in claim 16, wherein the secondary volume includes an additional volume.

18. The air spring device as claimed in claim 16, wherein the sealing apparatus is configured as one piece.

19. The air spring device as claimed in claim 16, wherein the sealing element and/or the main body comprises a rubber and/or plastic.

20. The air spring device as claimed in claim 16, wherein the sealing element includes a sealing lip.

21. The air spring device as claimed in claim 20, wherein the sealing lip is flexible.

22. The air spring device as claimed in claim 16, wherein the main body is configured as a ring or as a cylinder.

23. The air spring device as claimed in claim 16, wherein the sealing apparatus is integrated into a stop element, or the main body forming at least one part of the stop element.

24. The air spring device as claimed in claim 20, wherein an angle measured in a non-mounted state between a face of the main body, on which the sealing lip is arranged and the sealing lip is between 30° and 80°.

25. The air spring device as claimed in claim 24, wherein the angle is between 35° and 55°.

26. The air spring device as claimed in claim 25, wherein the angle is between 42° and 48°.

27. The air spring device as claimed in claim 16, wherein the ratio is between 0.91 and 0.97.

28. The air spring device as claimed in claim 27, wherein the ratio is between 0.87 and 0.96.

29. The air spring device as claimed in claim 16, wherein the sealing element projects with respect to the main body as viewed in the axial direction.

30. The air spring device as claimed in claim 16, wherein the sealing apparatus is arranged on or above the piston element as viewed in the axial direction on or above an upper side of the piston element, wherein the upper side faces the primary volume and adjoins the connecting duct.

31. The air spring device as claimed in claim 30, wherein the piston element includes cutouts configured to exchange ambient air, wherein the cutouts adjoin the sealing apparatus.

32. The air spring device as claimed in claim 16, wherein the sealing element bears against an inner side of the connecting duct or a side wall on the upper side of the piston element in the sealed position.
